(19) United States
(12) Patent Application Publication
(10) Pub. No.: US 2004/0251689 A1
(43) Pub. Date: Dec. 16, 2004

(54) Space colony factory unit with gravity generator

(75) Inventors: Yasunori Koizumi, Yokohama-shi (JP); Masateru Koga, Machida-shi (JP)

Correspondence Address: PAUL A. GUSS, PAUL A. GUSS ATTORNEY AT LAW, 775 S 23RD ST FIRST FLOOR SUITE 2, ARLINGTON, VA, 22202

(73) Assignee: Yugenkaisha Kisho, Tokyo (JP)

(21) Appl. No.: 10/461,358

(22) Filed: Jun. 16, 2003

(51) Int. Cl. H02P 9/04; B61C 9/38; B60L 11/02

(52) U.S. Cl. 290/1 R

(57) ABSTRACT

The present invention relates to a space colony factory unit with gravity generators which employ a number of widely known magnets to attract objects and human bodies so that the living condition in outer space is made almost as favorable as on the earth. Hence, working can be carried out smoothly in the space colony factory unit by flexible application of non-gravity state and artificial gravity. Jet engines are used to expose the space colony factory unit to sunlight for 20 hours per day for higher efficiency of power generation. Line of magnetic force devices of a view tower work to generate an air shielding layer to condition air better.

### BACKGROUND OF THE INVENTION

Up to the present, leading construction companies have presented the concepts of space colonies not only in the United States but also in other various countries. On the other hand, in these days, an international space station has already been in orbit and operations are now going on under the cooperation with countries in the world. Evidently because of its technological restriction and limited scale, the space station is not able to carry out further large-scale tasks such as the operation of interplanetary mobile rockets. Lack of a gravity generator of the present invention hereafter fully described is another reason that the activities by space astronauts have been inevitably insufficient so that the paramount purposes in the outer space age have not been achieved successfully. It is true that air conditioning has been already completed within the space station.

### SUMMARY OF THE INVENTION

The present invention is contemplated to eliminate the factors that are lacking in the space station as mentioned above.

It is an object of the invention to provide a gravity generator which uses widely known magnets and attracts objects and human bodies by magnetic forces to allow space workers to live and conduct activities in outer space. As the magnetic force of one magnet is indeed weak, a number of magnets, tens and hundreds thereof, must be applied in this respect and if so, lines of magnetic forces generated will be able to attract irons of human bodies to keep the human bodies from floating. The components of the gravity of the earth are the lines of magnetic forces from mountains and from under the ground, air pressures and the spinning and revolution of the earth. The gravity generator of the invention makes it possible to pursue lives in outer space fully covering vital aspects of clothing, eating and dwelling under the normal condition almost as seen on the earth. Within the space colony factory unit, the use of the gravity generator also enables the assembling of steel frames, welding, metal sheet work, the driving and locking of bolts and the like. Mixing and casting of concrete are also possible. The gravity generators are arranged anywhere on the walls and floors of the space colony factory unit which is furnished by the present invention and tens and thousands thereof are applied under an IC control. When performing large-scale assembling work within outer space, a special magnet crane is used and massive and heavy objects can be moved easily by turning ON or OFF power sources (switches). In the space colony factory unit, widely known power generation systems and solar power generation systems are employed and equipped with powerful engines such as nuclear fusion engines for higher efficiency of solar energy. When the space colony factory unit reaches its night position, the engines start jetting out for acceleration to shorten the time of it's staying under the shadow of the earth.

### BRIEF DESCRIPTION OF THE DRAWINGS

FIG. 1 is a front view of the space colony factory unit of the invention.

FIG. 2 is a cross sectional view taken on the line X-88 in FIG. 1.

FIG. 3 is a revolving door at a gate of a spaceship in a space airport.

FIG. 4 is a gravity generator (I).

FIG. 5 is an example illustrating how the inside of the chambers of the gravity generator is used.

FIG. 6 is a gravity generator (II).

FIG. 7(A) is a front view of a gravity generator (III).

FIG. 7(B) is a bottom view of the gravity generators in which five of those as shown in FIG. 7(A) are stacked.

### DESCRIPTION OF SIGNS

1: a magnifying lens

2: a visible range line of stars at night

3: a solar cell or a solar energy collection system

4: a gate of a spaceship

5: a spaceship

6: the body of a space colony factory unit (in which a power station, an engine unit and the like are located).

7: a rotary roof of a view tower

8: conditioned air

9: lines of magnetic forces (encircling the view tower)

10: a view tower

11: a track of the spaceship which travels

12: a visible range line of the earth

13: a floor of the space colony factory unit

14: a glass window

15: a track of the spaceship which travels

16: a space

17: a glass window

18: a space airport

19: a glass window

20: a spaceship

21: the body of the colony factory unit (assembly plant located inside)

22: a spaceship

23: a glass window

24: a shipping gate of finished products (allowing entry of space working boats)

25: the visible range line of earth

26: a floor of a warehouse on second floor

27: a window of flight deck

28: a step for a wheelchair of the view tower

29: the view tower

30: conditioned air

31: the lines of magnetic forces (encircling the view tower)

32: a rotary roof of the view tower

33: a solar cell or a solar energy collection system

34: a solar cell or a solar energy collection system

35: an elevator for transportation

36: lines indicating the movement of a working scaffold and an elevator

37: the position of a concrete conditioning device

38: an elevator for transportation

39: workers

40: colony blocks in production

41: a working scaffold

42: dwelling on third floor (containing a dining room or the like)

43: dwelling on second floor

44: dwelling on first floor

45: a line of magnetic force device

47: a working scaffold (mobile)

48: an elevator for transportation

49: an elevator for transportation

50: a working scaffold

51: an interplanetary mobile rocket in production

52: a line of magnetic force device

53: a rocket production platform

54: a floor of the space colony factory unit

55: an interplanetary mobile rocket

56: a crane with a magnet

57: a working scaffold

58: lines indicating the movement of a working scaffold and an elevator

59: a wall block of the space colony factory unit (quadruple structure)

60: an elevator for transportation

61: an elevator for transportation

62: a warehouse floor

63: an elevator for transportation

64: an elevator for transportation

65: the space airport (made of steel)

66: a rotary door of the gate of the spaceship

67: a spaceship

68: a rotary door of the gate of the spaceship

69: a space airport (made of steel)

70: a rotary door rotating device

72: a soft iron rod

73: a coil (enameled winding or silk winding)

74: a soft iron rod

75: a soft iron rod

76: a power source cord

77: a soft iron rod

y−1 to y−6: gravity generators

y−7 to y−12: lines of magnetic forces

y−13: people (human bodies)

78: the locking of the coil

79: a coil (enameled winding or silk winding)

80: the locking of a coil

81: a device supporter

82: a soft iron rod

83: the locking of a soft iron rod

84: a soft iron rod

85: the locking of a soft iron rod

86: a section of a soft iron rod

87: a soft iron rod

88: a coil (enameled winding or silk winding)

89: a power source cord

90: a soft iron rod

91: a soft iron rod

92: a power source cord

93: a coil (enameled winding or silk winding)

94 to 103: soft iron rods

104 to 113: Coils (enameled winding or silk winding)

### DETAILED DESCRIPTION OF THE INVENTION

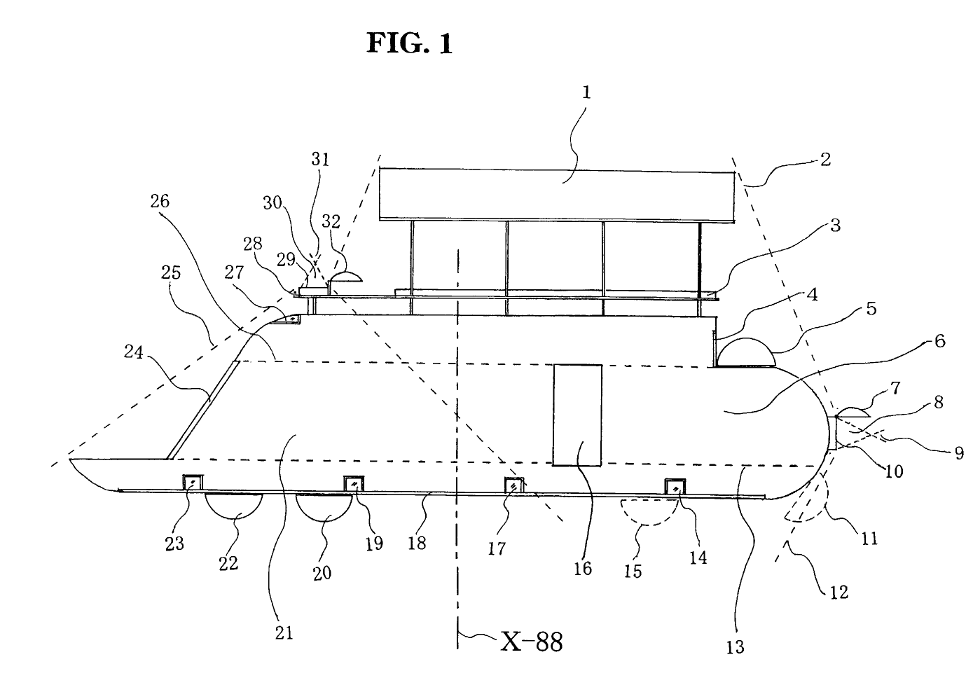

Referring first to FIG. 1, there is shown a magnifying lens at an upper part which is made of a resin or glass and fitted into a frame made of steel, a resin or the like (not illustrated) and a solar cell or a solar energy collection system 2 is provided away at a lower part in the drawing and the use of the magnifying lens will make the intensity of solar energy grow more than four times than ever. The magnifying lens, the solar cell and the solar energy collection system always move together and are automatically controlled with a motor and gears to turn in the direction of facing the sun (not illustrated) and the power produced by the arrangement of the components is transmitted to the factory and dwellings.

A view tower has a rotary roof as indicated by the numeral 32 and the rotary roof is differently used depending on the time zone <a> of letting it be exposed to the sun light and the time zone <b>, exposed to none thereof. In the case of <a>, the rotary roof is operated to shield the sun light and in the case of <b>, to allow the observation of the starry sky and it is turned by 180 to be kept from blocking thorough observation.

Line of magnetic force devices are arranged side by side on the entire circumference of the view tower 29 and work askew upward and the conditioned air 32 is held within the view tower maintaining a proper pressure, with the condition under which people in the view tower can breathe as adequately as on the earth. The conditioned air is always kept fresh with a purifier working through ducts. A plentitude of gravity generators are installed on the walls and floors of the view tower to attract the people, who are kept floating in outer space.

The whole portion as indicated by the numeral 18 given below is a space air port. The tracks of the spaceship 5 which travels are indicated by the lines 15 and 11. The numeral 4 indicates the gate for the spaceships. The numeral 6 indicates the body of the space colony factory unit in which the widely known power generators, engine units and the like are arranged (not illustrated).

The numeral 16 indicates a space for the purpose of preventing explosive sounds as caused by the operations of the widely known nuclear fusion engines or the generation of power.

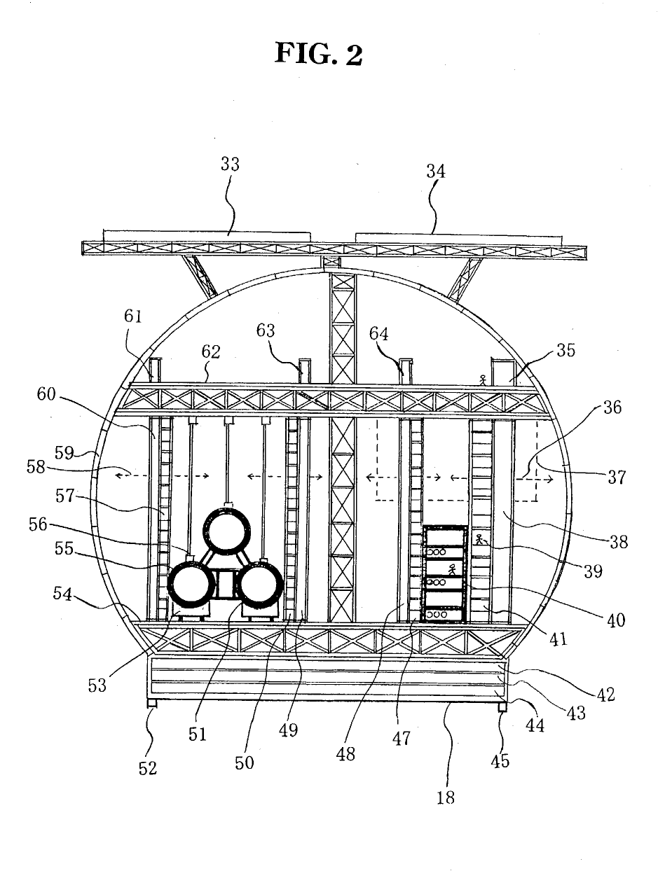

FIG. 2 is a cross sectional view taken on the line X-88 in FIG. 1. In the space colony factory unit located in the outer space, the power sources (switches) of the gravity generators can be turned ON or OFF to facilitate the carrying in or out of materials, various tanks and the like by adjusting the gravity at a strong, medium or weak level (not illustrated) at a warehouse. For full utilization of such a special situation in the outer space, the warehouse is located at an upper part of the space colony factory unit. The working scaffolds and the elevators in the factory are arranged integrally and are movable horizontally with upper and lower rails simultaneously. The working scaffolds can be set at arbitrary positions as designated by 60 and 61 for the numeral 57, by 49 and 63 for the numeral 50, by 48 and 64 for the numeral 47 and by 38 and 35 for the numeral 41 depending on the details of assembling and production work. They are so arranged as to facilitate the transferring of massive and heavy materials from the warehouse and hundreds and thousands of gravity generators are disposed on the walls and floors. The numeral 37 indicates the position of a concrete conditioning device and the numeral 54 the floor of the space colony factory unit. The numerals 55 and 51 indicate the description of how an interplanetary mobile rocket is produced and the numeral 40 the description of how blocks of the colony are assembled. The numerals 42, 43 and 44 (third, second and first floors) indicate living and dwelling zones of personnel.

In the factory, living is possible fully covering vital aspects of clothing, eating and dwelling under the conditions almost the same as on the earth. The ways of supplying and draining water are slightly different from those on the earth. Air pressure devices are mounted in the spaces above water supply tanks, drain purifying tanks, sewer disposal tanks and the like to always make air pressures work more intensely than on the earth so that flows in water feed and drain pipes run smoothly (not illustrated).

The numeral 18 given below the space colony factory unit indicates the space airport. Large line of magnetic force devices 52 and 45 are arranged on both sides thereof and attract the spaceship landing thereon. The spaceship lands completely, is transferred to a specified position and stopped. Then, a fixing device is started to work (not illustrated).

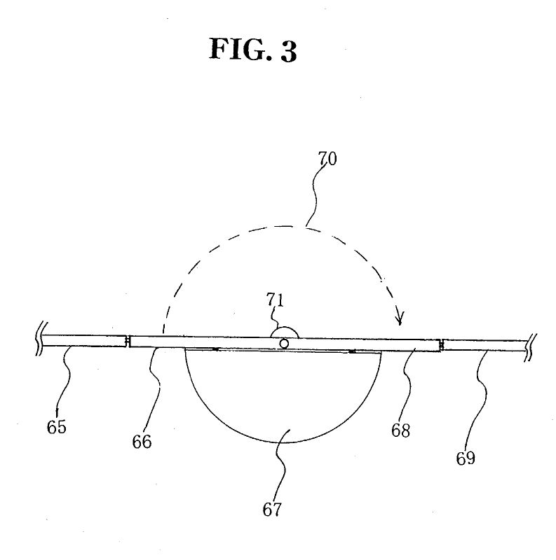

Referring to FIG. 3, the numerals 65 and 69 indicate the space airport. The spaceship 67 lands on the space airport and is transferred onto rotary doors 66 and 68 and when it reaches a specified position, the spaceship delivers a step outward, which is attracted by a magnet device and a fixing device attached to the door (not illustrated). Then, the door is turned by 180° with a rotating device 71 to let the spaceship or a space shuttle move into the space colony factory unit wherein the gravity generators are in operation so that passengers in the spaceship can get on or off as smoothly as on the earth. It is hoped that the time will come, sooner or later, when mankind can travel in spaceships to spend time inspecting the space colony factory unit or to enjoy the observation from the view tower for several days.

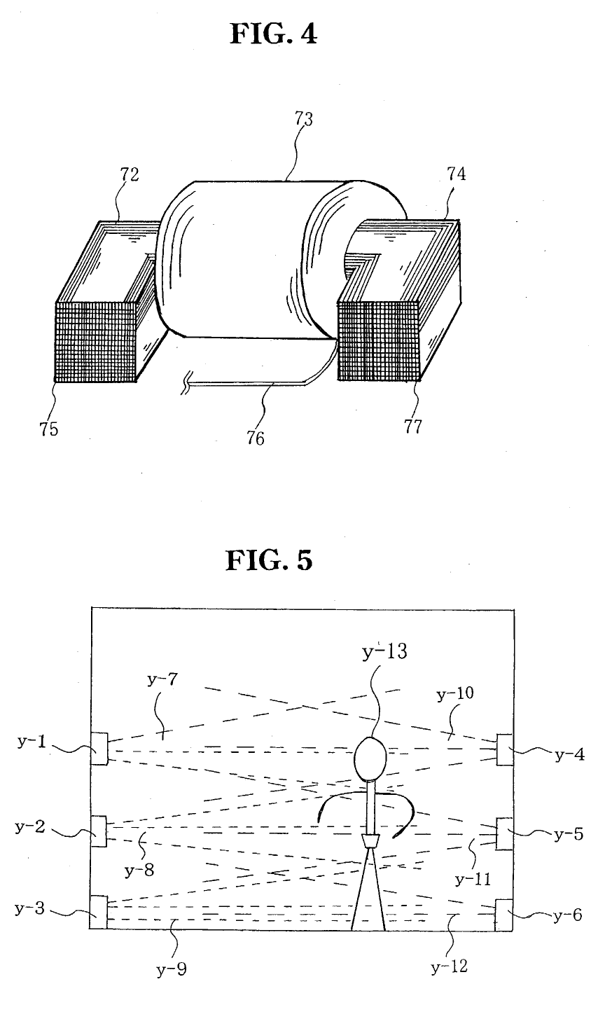

It is a widely known fact that electromagnets emit lines of magnetic forces. But, of course, it is impossible that the lines of magnetic forces of only one electromagnet attract objects or human bodies. When attracted by lines of magnetic forces from all directions and from upper, middle and lower levels, sophisticatedly being combined with proper working with tens and hundreds of magnets, human beings are kept from floating in outer space, which is made to maintain the requisite condition the same on the earth. FIG. 4 is an example of the gravity generator. The numerals 75, 72, 74 and 77 are soft iron rods. The numeral 73 indicates a coil (enameled windings and silk windings) and the numeral 57 the arrangement of hundreds of soft iron rods in such a manner as to distinguish the forces of magnets. FIG. 5 illustrates how the gravity generators work indoors. As human bones contain iron, heads, bodies, waists, feet and hands are attracted by the lines of magnetic forces from all directions to keep human bodies from floating in outer space. According to the scripture, God created human beings, and it is believed by me that the amount of iron contained in the human bones was adjusted to match relations between the motion of the human bodies and the intensity of magnetic forces from a point of view of the gravity. It is a widely known fact that the international space station as well as the space shuttle are revolving around the earth being supported by the lines of magnetic forces generated from mountains.

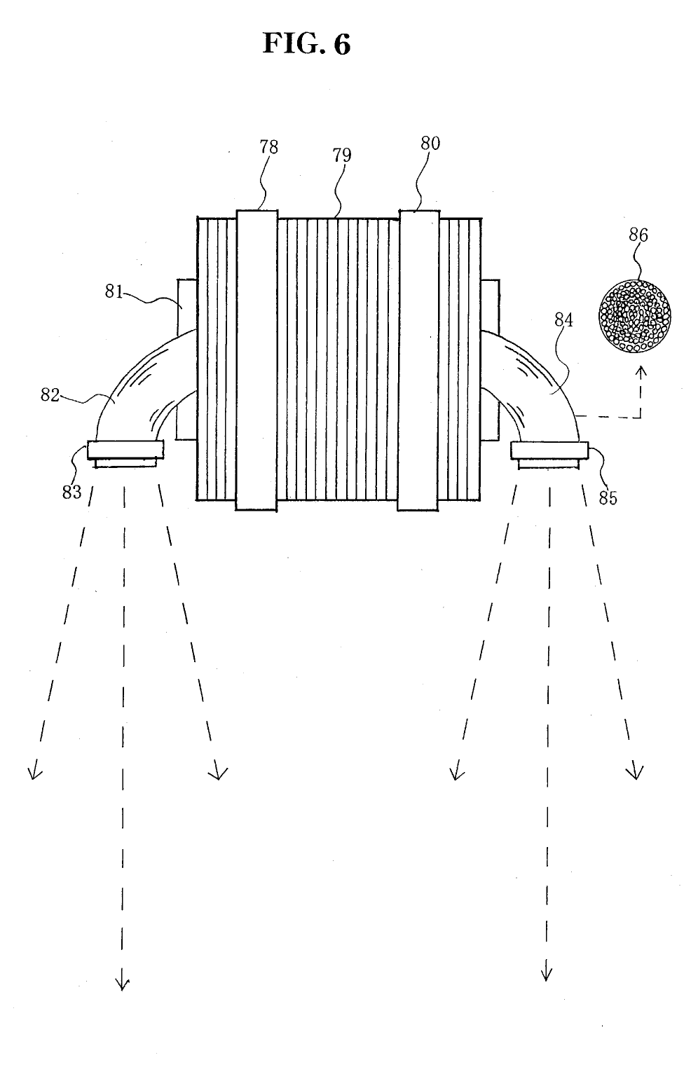

It is noted that the lines of magnetic forces inside the space station are less in intensity than those in the living sphere of the earth, which means that human bodies are caused to float in outer space. If we find technology for making up for such a factor lost in the sphere of outer space, it is presumed that we can enjoy lives in outer space as comfortably as on the earth. Of course, it must be proved that the new technology will cause no damage to human bodies. FIG. 6 is an example (II) of the gravity generator. The numerals 82 and 84 indicate the soft iron rods, the numeral 79 indicates the coil (enameled winding or silk winding), and the numeral 86 indicates a cross sectional view of the soft iron rod.

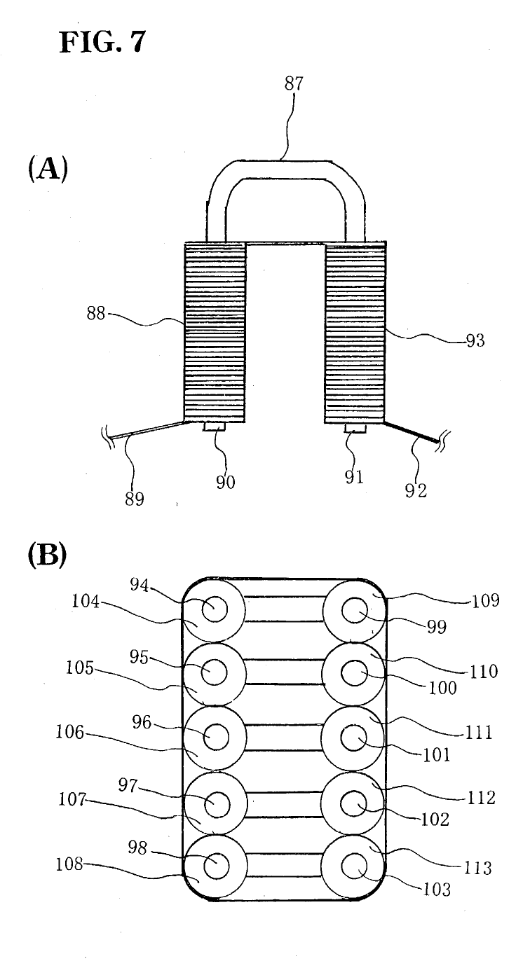

Referring to FIG. 7, there is shown a gravity generator (example III). FIG. (A) is a front view of the gravity generator The numerals 90, 91 and 87 are soft iron rods and the numerals 88 and 93 are coils (enameled windings or silk windings). FIG. (B) is a bottom view of the gravity generators in which five of the same ones as shown in the front view in FIG. (A) are stacked. The numerals 94 to 103 are soft iron rods and the numerals 104 to 113 are coils (enameled windings and silk windings). Examples of production methods of the gravity generators are shown in FIG. 5 (I), FIG. 6 (II) and FIG. 7 (III) and the methods are not limited to those as shown above. Other methods are possible by using widely known magnets (not illustrated). In any method, the gravity generators are placed in separate protective cases and arranged on walls and floors with mounting devices. The gravity generators are broadly applicable in vehicles, such as spaceships, rockets and space shuttles.

What is claimed is:

1. A space colony factory unit with gravity generators in which is installed widely known jet type engines enabling the space colony factory unit to be exposed to the sun light about 20 hour per day for accomplishing the further substantial operation of solar power generation system and a magnifying lens is provided above the solar power generation system.

2. The gravity generators in the claim 1 which employ widely known magnets in the outer space and as one thereof is weak for the purpose, tens and hundreds thereof are applicable with the number thereof not limited to attract human bones from all directions and from upper, middle and lower levels, with the condition which keeps human bodies from floating and allows people to pursue lives fully covering vital aspects of clothing, eating and dwelling and for working under living condition almost the same as on the earth.

3. A warehouse of the space colony factory unit in the claim 1 which is built at an upper part therein and accomplishes smooth working by combining non-gravity state and artificial gravity and working scaffolds and elevators are arranged on upper lower and rails to be made movable depending on the details of assembling.

4. A view tower in the space colony factory unit in the claim 1 from which the observation of the earth can be done through a glass window with a structure that enables full enjoyment of the view in the outer space.

5. A space air port built at a lower part of the space colony factory unit in the claim 1 which is made of steel and travels stably around the earth catching lines of magnetic forces from the earth and has five rotary doors or so at the center thereof for the entry or exit of the spaceships or the space shuttles.

6. An air pressure device in a space each above water supply and drain tanks in the space colony factory unit in the claim 1 which enables smooth flowing of water in the supplying and the draining of water by more intense air pressures than on the earth (not illustrated).
